(19) United States
(12) Patent Application Publication
(10) Pub. No.: US 2010/0009146 A1
(43) Pub. Date: Jan. 14, 2010

(54) HIGHLY INFRARED RAY REFLECTIVE POLYVINYLCHLORIDE ARTIFICIAL LEATHER

(75) Inventor: Chae Hwan Hong, Gyeonggi-do (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KIA MOTORS CORPORATION, Seoul (KR)

(21) Appl. No.: 12/335,651

(22) Filed: Dec. 16, 2008

(30) Foreign Application Priority Data
Jul. 10, 2008 (KR) 10-2008-0067211

(51) Int. Cl. B32B 7/02; B32B 27/00; B32B 5/18; B32B 5/16

(52) U.S. Cl. 428/215; 428/319.7; 428/317.9

(57) ABSTRACT

The present invention relates to a highly IR (infrared ray)-reflective polyvinyl chloride-based artificial leather, and particularly to a highly IR (infrared ray)-reflective polyvinyl chloride-based artificial leather comprising: (a) a surface layer comprising a black pigment mixture of a perylene black pigment and a carbon black pigment; (b) a foamed layer comprising a white titanium dioxide pigment and polyvinyl chloride resin; and (c) a substrate layer comprising a polyester fiber comprising a white titanium dioxide pigment. The surface layer of artificial leather herein transmits infrared ray while the foamed layer and the substrate layer reflected infrared ray, thereby lowering the temperature increase of the artificial leather of the present invention, and artificial leather herein is pleasant to the touch.

### CROSS-REFERENCE TO RELATED APPLICATION

This application claims under 35 U.S.C. §119(a) the benefit of Korean Patent Application No. 10-2008-0067211 filed Jul. 10, 2008, the entire contents of which are incorporated herein by reference.

### BACKGROUND

(a) Technical Field

The present invention relates to a highly Infrared Ray (IR) reflective polyvinyl chloride-based artificial leather comprising a surface layer, a formed layer and a substrate layer, in which the surface layer transmits infrared ray while the foamed layer and the substrate layer reflects infrared ray, thereby lowering the temperature increase of the artificial leather and providing a pleasant feeling of touch.

(b) Background Art

Leather is used as an interior material in various fields including automotive industry. It is, in general, refers to natural leather and artificial leather. As natural leather sheet can be obtained only one at a time by processing an animal skin, it is difficult to be mass-produced is difficult and is thus expensive. Also, various colors and uniform quality are difficult to obtain. In contrast, as artificial leather is prepared by using fabrics such as non-woven or woven fabrics, it does not involve the disadvantages of natural leather. However, it is inferior to natural leather in touch feel quality.

Conventional polymer artificial leathers are not satisfactory in various properties such as color, gloss, processability, design and touch feel. Among automotive interior parts, car seats requires a high level of touch feel quality on top of functional quality. Although the conventional polyvinyl chloride artificial leathers are widely used for seat covering material, they are still inferior to natural cowhides in emotional quality.

In particular, the temperature on the surface of artificial leather applied to seat covering material can increase up to 70° C. in the summer time, thus causing various problems. For example, a driver may feel hot when seated, and a long-term use can cause change in color, remove gloss and also generate cracks. There may occur whitening as plasticizer moves onto the surface of artificial leather.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

One of the objects of the present invention is to provide a provide polyvinyl chloride-based artificial leather which remarkably decreases the absorption of infrared ray.

In one aspect, the present invention provides a highly IR-reflective polyvinyl chloride-based artificial leather, which comprises a surface layer, a foamed layer and a substrate layer, in which the surface layer and foamed layer can pass infrared ray while the substrate layer can reflect.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other objects and aspects will be discussed in detail infra.

### BRIEF DESCRIPTION OF DRAWING

FIG. 1 shows the cross-section of a high IR-reflective polyvinyl chloride-based artificial leather of the present invention.

It should be understood that the appended drawing is not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to the preferred embodiments of the present invention, examples of which are illustrated in the drawing attached hereinafter. The embodiments are described below so as to explain the present invention by referring to the figure.

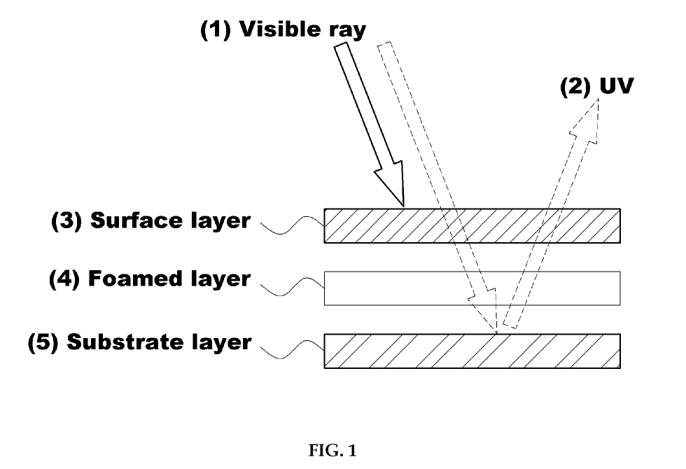

As schematically shown in FIG. 1, a highly IR-reflective polyvinyl chloride-based artificial leather of the present invention comprises a surface layer (3), a foamed layer (4), and a substrate layer (5). In a modified embodiment, the high IR-reflective polyvinyl chloride-based artificial leather may further comprise a coating layer depending on the use of the leather.

The surface layer may comprise 85-95 wt % of a polyvinyl chloride resin, 1-12 wt % of a black pigment mixture of a perylene black pigment and a carbon black pigment; and 1-10 wt % of a plasticizer. The foamed layer may comprises 45-60 wt % of polyvinyl chloride resin, 15-25 wt % of a titanium dioxide pigment, and 25-40 wt % of a plasticizer. The substrate layer may comprise a polyester fiber comprising 2-7 wt % of a titanium dioxide pigment.

The surface layer reflects a visible ray, while transmitting an infrared ray. Polyvinyl chloride resin (“PVC resin” hereinafter) with average molecular weight of 1,000-1,500 g/mo is preferred for the surface layer. When the average molecular weight is lower than 1,000 g/mol, abrasion resistance and tensile strength may be deteriorated when applied to a seat covering material. When the average molecular weight is higher than 1,500 g/mol, it may incur an overload during a process due to excessive increase in melting point. The PVC resin is used preferably in the amount of 85-95 wt %, more preferably 85-90 wt %, relative to the total weight of a composition used for preparing the surface layer. When the amount is less than 85 wt %, abrasion resistance and durability can be deteriorated due to surface friction. When the amount is more than 95 wt %, excessive increase in melting point can be caused, thus inhibiting the manufacture of raw fabric.

The black pigment is used for expressing black color of artificial leather. Examples of black pigment include carbon black, aniline black, iron oxide black, chrome oxide black and a mixture of three coloring agents. A most preferred one is carbon black. The black pigment absorbs light ranging from UV to near infrared ray of wavelength ranging from solar infrared ray to thermal radiation. Thus, material coated with the black pigment is remarkably heated by direct solar radiation. Such a problem can be prevented by using a mixture of a perylene black pigment and a carbon black pigment is used as black pigment.

The perylene black pigment absorbs only a small amount of visible range because it transmits infrared ray and absorbs light of wavelength ranging about 650-700 nm. Therefore, the perylene black pigment has greenish tinge, more exactly greenish with less white, instead of neutral black. For this reason, the carbon black pigment is mixed with the perylene black pigment to express complete black. One example of the perylene black pigment is N,N′-di-bis(2-(4-phenyl)ethyl)perylene-3,4,9,10-bis(dicarboximide). Preferably, the perylene black pigment and carbon black pigment are mixed in a ratio of 1.5-6:1, more preferably 1.5-4.5:1, by weight. When the mixing ratio is less than 1.5:1 weight ratio, the transmission of infrared ray may not be sufficient. When the mixing ratio is more than 6:1, the expression of black may not be sufficient.

The black pigment is used in the amount of 1-12 wt % relative to the total weight of a composition used for preparing the surface layer. When the amount is less than 1 wt %, it may result in non-uniformity in color. When the amount is more than 12 wt %, it requires the addition of excessive pigment, thus increasing the cost of the final product.

Examples of the plasticizer include phthalate-based plasticizer, trimellitic acid-based plasticizer, epoxy-based plasticizer and polyester-based plasticizer. Preferable examples of the plasticizer include dibutyl phthalate, diethylhexyl phthalate, diisononyl phthalate, diisodecyl phthalate), triethylhexyl trimellitate, triisononyl trimellitate and a polyester-based plasticizer with a low degree of polymerization (an average molecular weight of 1,000-8,000 g/mol).

This plasticizer is used in the amount of 1-10 wt % relative to the total weight of a composition used for preparing the surface layer. When the amount is less than 1 wt %, flexibility of artificial leather may not be sufficient. When the amount is more than 10 wt %, plasticizer can move onto the surface of raw fabric, thus causing deterioration in quality (e.g., gloss and color) of final product.

The foamed layer is coated on a surface of the substrate layer by calendaring polyvinyl chloride resin, thus providing comfortable cushiony feeling to artificial leather. This layer is required to show high level of reflectivity of infrared ray transmitted through the surface layer.

As one of ingredients of the foamed layer, the PVC resin is used in the amount of 45-60 wt % relative to the total weight of a composition used for preparing the foamed layer. When the amount is less than 45 wt %, the mechanical strength of foamed shell structure may not be sufficient, thus disintegrating a foamed layer. When the amount is more than 60 wt %, non-uniformity in a foamed layer can be caused due to excessive increase in viscosity. The PVE resins described above with respect to the surface layer can also be used for the foamed layer.

The titanium dioxide pigment, a white pigment, is used in the amount of 15-25 wt %, more preferably 15-20 wt %, relative to the total weight of a composition used for preparing the foamed layer. When the amount is less than 15 wt %, reflectance of infrared ray and the resulting temperature decrease may not be sufficient. When the amount is more than 25 wt %, elongation of final product may not be sufficient due to the addition of excessive amount of inorganic particles. Preferable particle size of the titanium dioxide pigment is 20-50 μm. When the size is outside the aforementioned range, reflectance of infrared ray may not be sufficient due to non-uniform dispersion of particles during the calendaring process.

The plasticizers described above with respect to the surface layer can also be used for the foamed layer. The plasticizer is used in the amount of 25-40 wt %, more preferably 30-40 wt %, relative to the total weight of a composition used for preparing the foamed layer. When the amount is less than 25 wt %, the final product may not be suitable for automotive seat covering material due to the increase in the stiffness of the final raw fabric product. When the amount is more than 40 wt %, plasticizer can move onto the surface of raw fabric, thus causing deterioration in quality of final product.

The substrate layer, the lowest layer of artificial leather, is affixed to an upper petrochemical resin, and provides properties like natural leather. Examples of a material that can be used for the substrate layer include woven fabric comprising polyester fiber, non-woven fabric, knitted fabric and a combination thereof. Either napped or non-napped fabric can be used for the substrate layer.

In the present invention, the substrate layer shows high level of reflectance of infrared ray that transmits upper layers (i.e., a surface layer and a foamed layer). For this purpose, the substrate layer includes polyester fiber comprising 2-7 wt % of titanium dioxide pigment. When the amount is less than 2 wt %, IR reflectance of the substrate layer may not be sufficient. When the amount is more than 7 wt %, IR reflectance levels off, thus causing economic disadvantages. Preferable particle size of the titanium dioxide is 1-50 μm. When the size is smaller than 1 μm, the spinning of fiber can be difficult. When the size is larger than 50 μm, surface quality can be deteriorated due to non-uniform dispersion of particles.

A preferable thickness of the surface layer, the foamed layer and the substrate layer is 0.1-0.3 mm, 0.6-0.9 mm and 0.2-0.4 mm, respectively. Total thickness of three layers is preferably 1.0-1.5 mm. When the thickness of the surface layer is less than 0.1 mm, abrasion resistance of the surface layer of final product may not be sufficient. When the thickness of the surface layer is larger than 0.3 mm, embossing expression can be unclear after the surface embossing process on surface, and the transmission of infrared ray reflected by a foamed layer and a substrate layer may not be sufficient, thus lowering the effect of the present invention, i.e., the inhibition of surface temperature. When the thickness of the foamed layer is less than 0.6 mm, cushiony feeling may not be sufficient when applied to seat covering material. When the thickness of the foamed layer is larger than 0.9 mm, the artificial leather can be too cushiony. When the thickness of the substrate layer is less than 0.2 mm, tensile strength of the final product may not be sufficient. When the thickness of the substrate layer is larger than 0.4 mm, the appearance of final product can be stiff instead of soft due to excessive increase in tensile strength. When the total thickness of the artificial leather is less than 1.0 mm, tensile strength and tear strength of final product may not be sufficient. When the total thickness is greater than 1.5 mm, the appearance of final product can be stiff, thus deteriorating quality of raw fabric.

The above-described artificial leathers can be applied to seats of any kind of transportation means, preferably automotive seats.

### EXAMPLES

The following examples illustrate the invention and are not intended to limit the same.

### Examples 1-5 and Comparative Examples 1-3

Artificial leathers were prepared by stacking a substrate layer, a foamed layer and a surface layer, which have the contents shown in Table 1. The foamed layer were stacked on the substrate layer by calendaring a mixture of PVC resin, titanium dioxide pigment and plasticizer, and the surface layer was also calendared on the foamed layer. The surface layer was prepared by stirring a mixture of polyvinyl chloride resin and perylene black and carbon black in a stirring-mixing device for 10-20 minutes and melting the mixture at 200° C. with a roller.

The thickness of the surface layer, the foamed layer and the substrate layer were 0.2 mm, 0.7 mm and 0.2 mm, respectively.

### Comparative Example 4

An artificial leather was prepared in the same method as in Example 2 except that the thickness of the surface layer was 0.5.

TABLE 1

| Ingredients | | | Examples | | | | | Comp. Ex. | | |
|---|---|---|---|---|---|---|---|---|---|---|
| (wt %) | | | 1 | 2 | 3 | 4 | 5 | 1 | 2 | 3 |
| Surface | PVC resin¹⁾ | | 85 | 90 | 87 | 90 | 90 | 85 | 85 | 85 |
| layer | Black | Perylene black pigment²⁾ | 3 | 3 | 6 | 3 | 3 | — | 3 | 3 |
| | pigment | Carbon black pigment³⁾ | 2 | 2 | 2 | 2 | 2 | 5 | 2 | 2 |

| | Plasticizer⁴⁾ | 10 | 5 | 5 | 5 | 5 | 10 | 10 | 10 |
|---|---|---|---|---|---|---|---|---|---|
| | Total | 100 | | | | | | | |
| Foamed | PVC resin¹⁾ | 50 | 53 | 50 | 47 | 53 | 55 | 70 | 50 |
| layer | Titanium dioxide pigment⁵⁾ | 15 | 17 | 15 | 23 | 17 | 10 | — | 15 |
| | Plasticizer⁴⁾ | 35 | 30 | 35 | 30 | 30 | 35 | 30 | 35 |
| | Total | 100 | | | | | | | |
| Substrate | Polyester fiber⁶⁾ | 95 | 98 | 95 | 98 | 94 | 95 | 95 | 100 |
| layer | Titanium dioxide pigment⁷⁾ | 5 | 2 | 5 | 2 | 6 | 5 | 5 | — |

| | |
|---|---|
| Total | 100 |

¹⁾PVC resin: polyvinyl chloride resin (LG CHEM, PB1302 product)
²⁾Perylene black pigment: BASF Product
³⁾Carbon black pigment: Korea Carbon Black Corp.
⁴⁾Plasticizer: diethylhexylphthalate
⁵⁾Titanium dioxide pigment of the foamed layer: titanium dioxide with an average particle size of 20 μm
⁶⁾Polyester fiber: Huvis Corp.
⁷⁾Titanium dioxide pigment of the substrate layer: titanium dioxide with an average particle size of 5 μm

### Test Example 1

### Measurement of Temperature Increase on the Surface

The polyvinyl chloride-based artificial leathers prepared in Examples 1-5 and Comparative Examples 1-4 were irradiated by using a solar simulator, the specifications of which are shown in Table 2. Temperature increase on the surface was measured and the results are presented in Table 3.

TABLE 2

| | |
|---|---|
| Lamp Type | Xenon Short Arc |
| Lamp Power | 150 W |
| Range of | 50 mm × 50 mm |
| Irradiation | |

TABLE 3

| Temperature | Examples | | | | | Comp. Ex. | | | |
|---|---|---|---|---|---|---|---|---|---|
| (° C.) | 1 | 2 | 3 | 4 | 5 | 1 | 2 | 3 | 4 |
| After 10 minutes | 35 | 34 | 34 | 35 | 34 | 35 | 35 | 35 | 34 |
| After 30 minutes | 42 | 40 | 41 | 40 | 41 | 45 | 45 | 46 | 43 |
| After 60 minutes | 55 | 51 | 52 | 52 | 51 | 75 | 75 | 76 | 60 |

As shown in Table 3, the temperature increase was drastically lowered in Examples 1-5 as compared to Comparative Examples 1-3. This ascertains the effect of a surface layer comprising perylene black and highly-reflective foamed layer and substrate layer comprising titanium dioxide pigment. Further, Comparative Example 4, which was different from Examples in the thickness of the surface layer, showed intermediate increase of temperature between Comparative Examples 1-3 and Examples 1-5 after the 60-minute irradiation.

### Test Example 2

### Measurement of Properties

Tensile properties and burst strength of PVC artificial leather raw fabric prepared in Examples 1-5 and Comparative Examples 1-3 were measured. For the measurement of tensile properties, dumbbell-shaped specimens were cut according to ASTM D 638.

Tensile Properties

Specimens were prepared and tensile properties were measured by using a UTM (Universal Testing Machine) according to ASTM D 638 (Standard Test Method for Tensile Properties of Plastics). Tensile strength and elongation at break were calculated by using the following mathematical formula.

Tensile strength (Pa)=Max. load (load, N)÷Initial surface area of specimen (m²) Mathematical Formula 1

Elongation at break (%)=((Length at break)×100)/Initial length

Burst Strength

Samples (100 mm×100 mm×100 mm) were prepared by using plastic sheet, film, fiber and paper. The samples were perpendicularly pushed with a rubber membrane, and resistance at break was measured according to ASTM D774 by using a burst strength testing machine (Mullen-type). Burst strength means a pressure value measured when a rubber membrane breaks a sample. Three values were averaged and the results are presented in Table 4.

TABLE 4

| | Measured properties | | |
|---|---|---|---|
| | Tensile strength | Elongation at break | Burst strength |
| Examples | (MPa) | (%) | (MPa) |
| Ex. 1 | 4.8 | 150 | 1.0 |
| Ex. 2 | 4.7 | 153 | 0.99 |
| Ex. 3 | 4.8 | 149 | 1.0 |
| Ex. 4 | 5.0 | 150 | 1.0 |
| Ex. 5 | 4.9 | 148 | 0.99 |
| Comp. Ex. 1 | 4.5 | 130 | 0.8 |
| Comp. Ex. 2 | 4.4 | 138 | 0.9 |
| Comp. Ex. 3 | 4.8 | 150 | 0.89 |
| Comp. Ex. 4 | 4.9 | 151 | 0.99 |

As shown in Table 4, the artificial leathers of Examples 1-5 were ascertained as superior in tensile strength, elongation at break and burst strength.

As described above, the present artificial leathers show a lower level of absorption of infrared ray, do not involve deterioration of gloss and crack after a long-term use caused by the temperature elevation, and prevent whitening problem.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A highly IR-reflective polyvinyl chloride-based artificial leather comprising:
(a) a surface layer comprising a polyvinyl chloride resin, a black pigment mixture of a perylene black pigment and a carbon black pigment, and a plasticizer;
(b) a foamed layer comprising a polyvinyl chloride resin, a titanium dioxide pigment, and a plasticizer; and
(c) a substrate layer comprising a polyester fiber comprising a titanium dioxide pigment.

2. The artificial leather of claim 1, wherein:
(a) the surface layer comprises 85-95 wt % of a polyvinyl chloride resin, 1-12 wt % of a black pigment mixture of a perylene black pigment and 1-10 wt % of a plasticizer;
(b) the foamed layer comprises 45-60 wt % of a polyvinyl chloride resin, 15-25 wt % of a titanium dioxide pigment and 25-40 wt % of a plasticizer; and
(c) the substrate layer comprises a polyester fiber comprising 2-7 wt % of a titanium dioxide pigment.

3. The artificial leather of claim 2, wherein the black pigment is a mixture of the perylene black pigment and the carbon black pigment in a weight ratio of 1.5-6:1.

4. The artificial leather of claim 2, wherein the titanium dioxide pigment of the foamed layer comprises titanium dioxide particles with a size of 20-50 μm.

5. The artificial leather of claim 2, wherein the titanium dioxide pigment of the substrate layer comprises titanium dioxide particles with a size of 1-50 μm.

6. The artificial leather of claim 1, wherein the artificial leather is used for an automotive seat.

7. The artificial leather of claim 1, wherein the thickness of the surface layer is 0.1-0.3 mm, the thickness of the foamed layer is 0.7-0.9 mm, the thickness of the substrate layer is 0.2-0.4 mm, and the total thickness of the artificial leather is 1.0-1.5 mm.
